(19) United States
(12) Patent Application Publication
(10) Pub. No.: US 2005/0172149 A1
(43) Pub. Date: Aug. 4, 2005

(54) Method and system for management of information for access control

(76) Inventors: Xingjian Xu, Singapore (SG); Yingzi Wu, Singapore (SG); Puay Siew Tan, Singapore (SG); Yushi Cheng, Singapore (SG)

Correspondence Address: KNOBBE MARTENS OLSON & BEAR LLP, 2040 MAIN STREET, FOURTEENTH FLOOR, IRVINE, CA, 92614, US

(21) Appl. No.: 10/915,733

(22) Filed: Aug. 10, 2004

(30) Foreign Application Priority Data
Jan. 29, 2004 (SG) 200400460-2

(51) Int. Cl. G06F 12/14; G06F 15/173; G06F 15/16

(52) U.S. Cl. 713/200; 713/155; 709/225; 709/229

(57) ABSTRACT

A system for management of information for access control to resources is disclosed. The system may comprise a user management unit for managing information associated with individual users of the resources; a context management unit for managing context information associated with a plurality of users; an access control management unit for assigning an access authority to each user, wherein the access control management unit bases the assignment of the access authority on the information associated with individual users of the resources from the user management unit and the context information associated with a plurality of users from the context management unit.

### FIELD OF INVENTION

The invention generally relates to managing dynamic user information in computer systems for secure user access control to diverse information resources.

### BACKGROUND

User access management (UAM) is an important concern in computer network systems, where secure access of information resources is limited to only authorized users. In such networks having many users and diverse information resources, dynamic management of the user information is critical. For example, some information resources include information relating to human resource records, business records, medical records, and the like. UAM is a fundamental function required to support business processes and information management functions. UAM typically has two inter-related categories of management of information: user information and user access control information.

User information management (UIM) describes mechanisms that manage user information and groups of user information. The major function of UIM in computer network systems is to manage the lifecycle of user accounts. For example, establishing of user accounts, update of user accounts, and the removal of user accounts are some of the core and basic functions of UIM requirements. An additional UIM requirement is management of user information into logical groupings, called group information management (GIM). One example GIM is the organizational structure of a company.

User access control management (UACM) describes security mechanisms that mediate users' access to resources. Such resources may include computational resources, files, processes, or even services offered. From a software point of view, all resources may be seen as abstract data types allowing different operations to be applied. The traditional method is role-based access control, where access control is enabled in the following manner:

1) determine who (user) is requesting access;

2) determine the role(s) of the user; and

3) determine the type of access that is allowed based on the role(s) of the user.

The main task of the access control mechanism is to ensure that only processes, which are explicitly authorized, perform the operation.

In current user UAM systems, the user definition is static and tightly coupled with specific applications, and user information is classified with respect to organizational structure. One reason for this is that traditionally UAM systems are mainly for simplifying administration and management of privileges, where the whole organization and the operations are well defined.

At least preferred embodiments of the present invention provide a method and a system to manage user information and access control in flexible and dynamic ways.

### SUMMARY

In accordance with a first aspect of the present invention, there is provided a method for management of information for access control to resources, the method comprising the steps of managing information associated with individual users of the resources; managing context information associated with a plurality of users; assigning an access authority to each user, wherein the assignment of the access authority is based on the information associated with individual users of the resources and the context information associated with a plurality of users.

In one embodiment the context information comprises grouping Information identifying a plurality of individual users as belonging to a group of users.

In one embodiment the context information comprises temporal information on relationships between individual users and/or groups of users.

The method may comprise the steps of assigning different access levels to different access authority elements and assigning the user and/or group of users as belonging to one of the access levels, wherein the user and/or group of users in an access level hierarchically above one or more other access levels are assigned the access authority elements of said one access level and of the one or more other access levels.

The assigning of the user/or group of users as belonging to one of the access levels may further be based on the temporal information on the relationships between individual users and/or group of users.

Preferably, one or more of the information associated with individual users of the resources, the context information associated with a plurality of users, and the access authority are in a format supporting inter- and intra-entity management of information for access control to the resources.

In accordance with a second aspect of the present invention, there is provided a system for management of information for access control to resources, the system comprising a user management unit for managing information associated with individual users of the resources, a context management unit for managing context information associated with a plurality of users, an access control management unit for assigning an access authority to each user, wherein the access control management unit bases the assignment of the access authority on the information associated with individual users of the resources from the user management unit and the context information associated with a plurality of users from the context management unit.

In one embodiment the context information comprises grouping Information identifying a plurality of individual users as belonging to a group of users.

In one embodiment the context information comprises temporal information on relationships between individual users and/a group of users.

The access control management unit may assign different access levels to different access authority elements and assigns the user and/or group of users as belonging to one of the access levels, wherein the user and/or group of users in an access level hierarchically above one or more other access levels are assigned the access authority elements of said one access level and of the one or more other access levels.

In one embodiment, the access control management unit further basis the assigning of the user and/or group of users as belonging to one of the access levels on temporal information on the relationships between individual users and/or group of uses.

Preferably, one or more of the information associated with individual users of the resources, the context information associated with a plurality of users, and the access authority are in a format supporting inter- and intra-entity management of information for access control.

In accordance with a third aspect of the present invention there is provided a data storage medium containing computer readable code for instructing a computer to perform a method for management of information for access control to resources, the computer readable code instructing the computer to manage information associated with individual users of the resources; manage context information associated with a plurality of users; assign an access authority to each user, wherein the assignment of the access authority is based on the information associated with individual users of the resources and the context information associated with a plurality of users.

### BRIEF DESCRIPTION OF THE DRAWINGS

Embodiments of the invention will be better understood and readily apparent to one of ordinary skill in the art from the following written description, by way of example and in conjunction with the drawings, in which:

FIG. 1 is a schematic drawing illustrating a UAM system embodying the present invention.

FIG. 2 is a schematic drawing illustrating an example namespace implementation for a UAM system embodying the present invention.

FIG. 3 is a schematic drawing illustrating an example configuration of the UAM system of FIG. 1.

FIG. 4 is a schematic drawing illustrating another example configuration of the UAM system of FIG. 1.

FIG. 5 is a schematic drawing illustrating an example temporal context implementation for a UAM system embodying the present invention.

FIG. 6 is a schematic drawing illustrating an example role assignment implementation for a UAM system embodying the present invention.

FIG. 7 is a schematic drawing illustrating an example access level implementation for a UAM embodying the present invention.

FIG. 8 is a schematic drawing illustrating a computer system for implementing UAM embodying the present invention.

### DETAILED DESCRIPTION

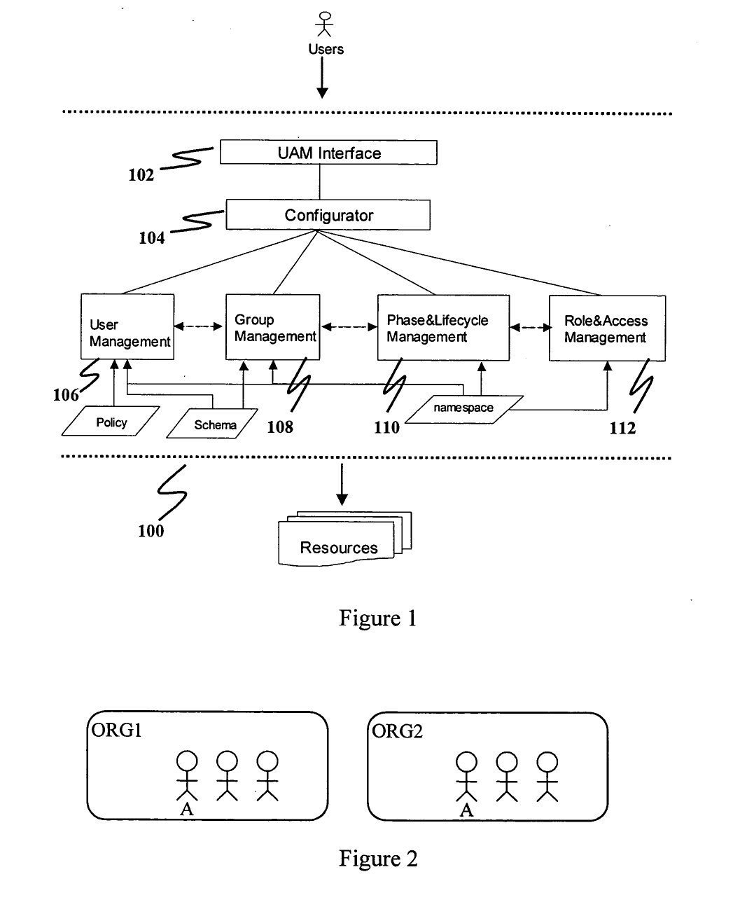

FIG. 1 shows an overall schematic diagram of a UAM system 100 embodying the present invention. The system 100 has a system interface 102 which can be configured by a Configurator 104, defining a set of UAM functions based on the specific UAM requirements for an application, being accessed e.g. via API call and SOAP invocations in a web service environment. Depending on the requirements in a particular application scenario, the modules 106, 108, 110 and 112 can be configured to provide functionalities implemented by individual modules only, or functionalities provided via a combination of these modules.

The modules 106, 108, 110 and 112 relate generally to two inter-related concepts in the management of information, User Information Management (UIM) and Access Control Management (ACM). UIM describes the mechanisms that manage user information and groupings (both functional and logical) of user information. In the example embodiment, it utilizes the User Management module 106, Group Management module 108 and Phase/Lifecycle Management module 10. In the example embodiment, the Group Management module 108 and Phase/Lifecycle Management module 110 provide context information associated with the individual users. ACM specifies security mechanisms that mediate users' access to resources. In the example embodiment it utilizes the Role&Access Management module 112.

Other than managing basic User information like username, password, etc., the User Management module 106 can also manage additional user information specific to individual applications via the means of extensible user-defined schemas.

The UAM system 100 enables applications to define different policies to govern User information like naming convention, password format, etc.

In the example embodiment, namespace is a method for qualifying User information. The User information is associated with namespaces, which can be qualified by using URI references for example.

Via namespaces, the UAM system 100 is able to model User information for multiple organizations concurrently. For example, in FIG. 2, User-A from ORG1 and the User-A from ORG2 can be differentiated through the associated namespaces of ORG1 and ORG2.

As a result, using a single User Management module 106, applications can host/support information from multiple organizations in the example embodiment. This feature is e.g. advantageous in Internet and distributed applications in a Service Oriented Architecture (SOA) environment, particularly relevant to service providers who host outsourced services for enterprises.

Returning to FIG. 1, the UAM system 100 can be configured to provide Group Management and User Management functionalities utilizing modules 108 and 106, to enable contextual UAM. In this configuration the following functionalities are available, in addition to those described above.

Using schemas, UAM system 100 can enable applications to specify various ways of grouping User information. Examples include but are not limited to:

Organizational Structure

The User information is grouped in terms of the organizational structure or companies, where the structure is normally hierarchical.

Project Structure

Grouping of User information based on projects that the users are involved in. Again, like the first instance, a hierarchical or relationship-based structure can be embedded into this scenario.

Logical Grouping

Grouping of User information according to logical relationships can also be supported.

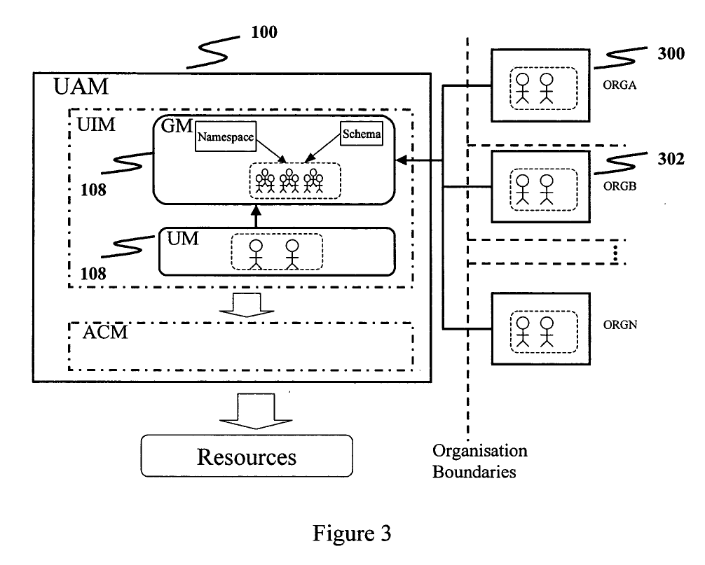

Furthermore, multiple organizations support can be provided, and includes e.g. two aspects:
The Group Management module 108 and/or the User Management module 106 can model group information of multiple organizations concurrently.
For a Group defined in the UAM system 100, the member Users can come from different organizations. For example in FIG. 3, for a group managed by Group Management module 108 in UAM system 100, its member Users may come from different organizations, like ORGA 300, ORGB 302, etc.

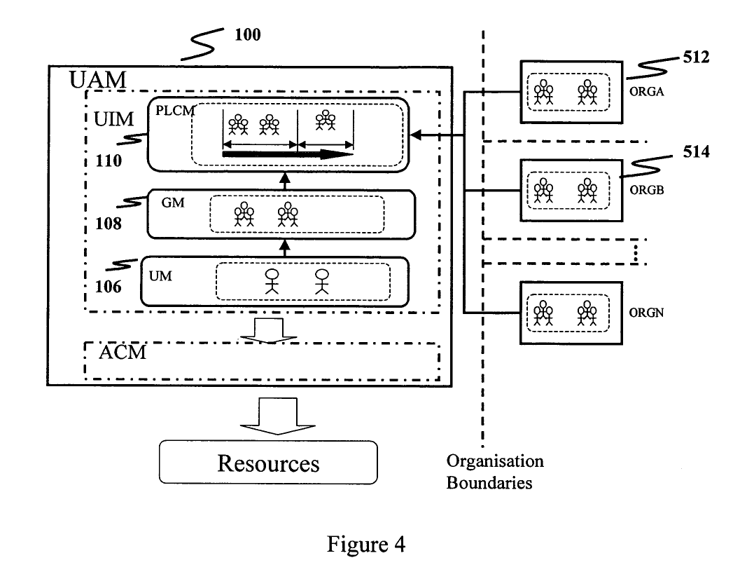

The UAM system 100 may be configured to utilize the User Management module 106, Group Management module 108, and Phase/Lifecycle Management module 110 to enable contextual UAM. This is illustrated in FIG. 4. In this configuration, the following additional functionalities are available:

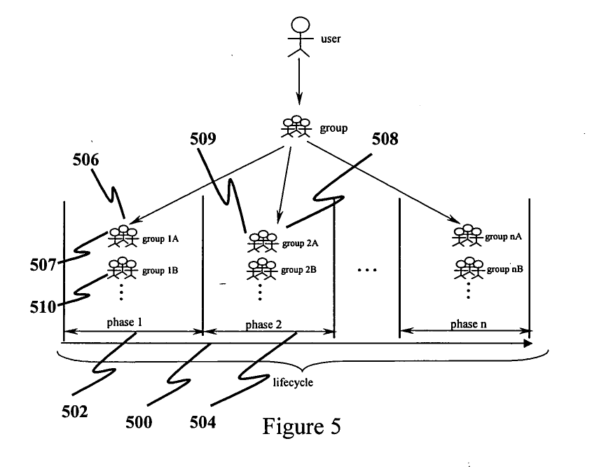

The Phase/Lifecycle Management module 110 in the example embodiment enables applications to specify temporal aspect of User information. As illustrated in FIG. 5, a project lifecycle may start when the project is initiated, and finish when the project is completed or terminated. Along the timeline 500 of the project lifecycle, there are sequential multiple phases e.g. 502, 504. In each phase, manpower is needed to fulfill all tasks that are allocated to the phase. The manpower is added in the form of groups e.g. 506, 508 of users e.g. 507, 509 and in each phase e.g. 502 there may be associated groups e.g. 506, 510. Eventually it is the member users of these groups that are responsible to fulfill the tasks. Thus, the temporal aspect of the User information is specified by associating a User's group with the phase of a project lifecycle, in the example embodiment.

The UAM system 100, through the Phase/Lifecycle Management module 110, can manage phase and lifecycle information of multiple organizations simultaneously. This is similar to User and group information managing described above and it also applies the namespace concept to achieve that in the example embodiment.

For example, for a certain phase of a lifecycle, the added groups can come from different organizations. Using FIG. 4 again, for a phase of a lifecycle that is managed by the Phase/Lifecycle Management module 110, the groups that are associated with the phases may either come from the groups managed by the Group Management module in the local UAM system 100, or from external sources, like ORGA 512, ORGB 514, etc.

Returning to FIG. 1, Access Control Management (ACM) is implemented as a single component, namely Role&Access Management module 112 in the example embodiment.

In the UAM system 100 context consciousness in role assignment is implemented. In this situation, context means the conditions under which the assignment of a role to a user is performed. It specifies a user's grouping(s) and temporal relationships captured by the UAM system 100.

Context consciousness means that the UAM system 100 can:
assign a role to a User,
specify the context when the role is assigned, and
retrieve the context of the assignment when needed.

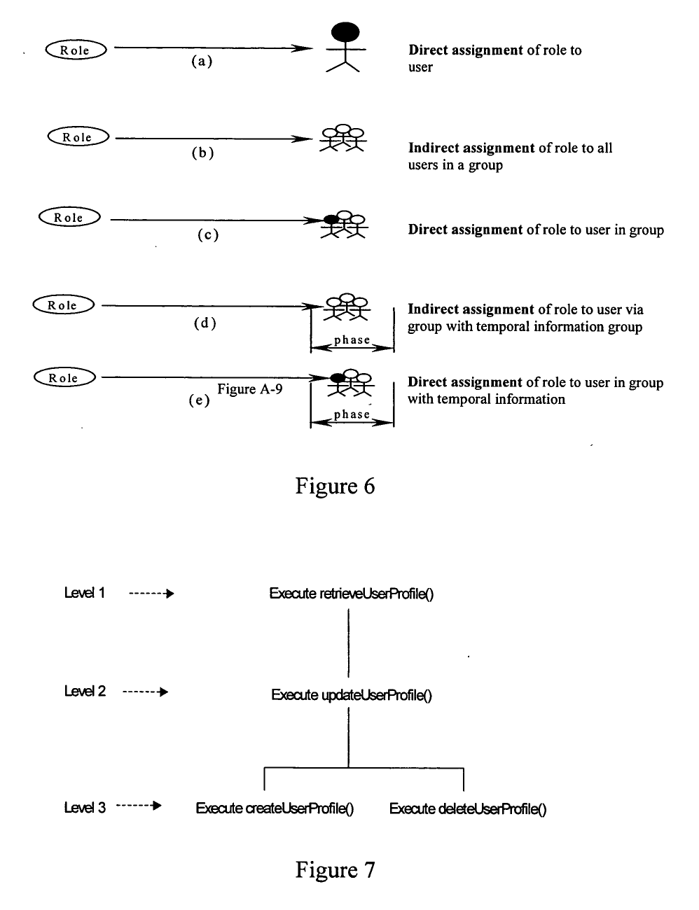

In FIG. 6, example applications of context are illustrated:

In FIG. 6 (a), a role is assigned to a user directly.

In FIG. 6 (b), a role is assigned to a user because the role is assigned to a group, and the user is member of the group; Here the grouping is the condition for assignment of role and the role assignment is for all users in the group, hence indirect;

In FIG. 6 (c), a role is assigned to a user directly when the user is in a group where the grouping is the condition for assignment of role to the said user only, direct but condition-based;

As depicted in FIG. 6 (d), a role is assigned to a user because the role is assigned to a group added to a phase in a lifecycle, and the user is member of the group. Here, the condition for assignment of role is the grouping of the user. The role assignment is for all users in the group and its temporal relationship to the particular phase, again indirect.

In FIG. 6 (e), a role is directly assigned to a user when the user is a member of a group which is also associated to a specific phase of a project lifecycle [condition]. Again the assignment is direct but conditioned-based.

The UAM system of the example embodiment can achieve fine-grained access levels by introducing an Access Level concept, which consists of logical groupings of access right. This decouples the traditional Role and Permission relation. A flexible extension of access level structure and relationships is made possible. Decoupling of the Role and Permission relation can be used to achieve fine-grained access control on operations of web services in the Service-Oriented Architecture (SOA).

An example of Access Structure and how fine-grained access control is achieved in the example embodiment is shown in FIG. 7. In this example, four operations in relation to a UserProfile are provided as access authority elements, namely:
retrieveUserProfile( )
updateUserProfile( )
createUserProfile( ), and
deleteUserProfile( ).

The UAM system of the example embodiment can enable fine-grained control of the access of these operations. In this example, the “child” (higher level) inherits the capability or accessibility of the “parent” (lower level) in the hierarchy. As such:

Any user with the role that is assigned to access Level 1 can only execute ‘retrieveUSerProfile’ operation.

Any user with the role that is assigned to access Level 2 can execute two operations of ‘retrieveUSerProfile’ and ‘updateUserprofile’.

Any user with the role that is assigned to Level 3 can execute three operations of ‘retrieveUSerProfile’, ‘updateUserprofile’, ‘deleteUserProfile’ and ‘createUserProfile’.

It is flexible to add in any operations in different access levels so as to enable the functions' accessibility by different roles. For example, when an operation ‘retrieveAllUserProfile’ is added to access Level 2, then all users with the role that is assigned to access Level 2 & Level 3 will be able to execute the operation ‘retrieveAllUserProfile’.

In the following, some of the advantages of embodiments of the present invention are summarized:

Context-Conscious Role Assignment

UAM embodying the present invention can assign a role to user in the context of e.g. grouping(s) and temporal relationship.

Service Centric Fine-Grained Access Control

Access level implementation in embodiments of the present invention decouples role and permission on resources and enables fine-grained access control on services implemented by e.g. service providers based on the Service-Oriented Architecture (SOA).

Multi-Organisation Support

All the entities in UAM embodying the present invention like user, group, phase/lifecycle, role, access level, etc., can be of multiple organizations. UAM embodying the present invention supports the management of these entities across multiple organizations simultaneously and supports the establishment of complex relationships among the entities that exist in different organizations.

Flexible Configurations of Application Usage Using Modular Components

UAM embodying the present invention can be configured to perform functionalities of individual components of User Management, Group Management, Phase/Lifecycle Management and Role&Access Management and also the functionalities of any combinations of the components. To facilitate flexible configurations of a UAM embodying the present invention one example implementation could utilise a method and system described in co-pending Singaporean patent application entitled “Method And System For Data Retrieval From Heterogeneous Data Sources”, filed on 14 Jan. 2004 in the name of the present applicant. This can include an implementation where not all of the respective modules are present at one or more of the entities, i.e. the relevant data for performing the functionality may be accessed from remote locations/entities.

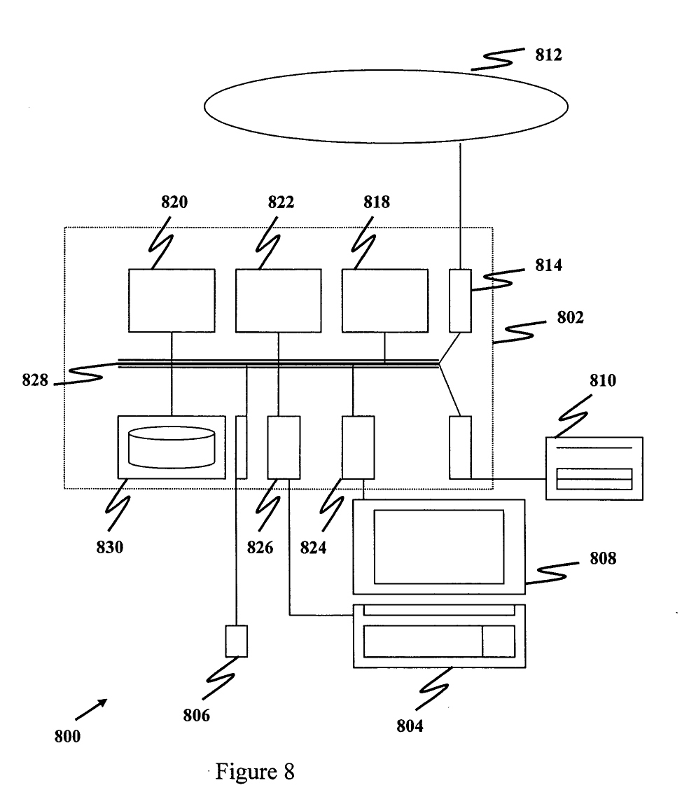

The method and system of the example embodiment can be implemented on a computer system 800, schematically shown in FIG. 8. It may be implemented as software, such as a computer program being executed within the computer system 800, and instructing the computer system 800 to conduct the method of the example embodiment.

The computer system 800 comprises a computer module 802, input modules such as a keyboard 804 and mouse 806 and a plurality of output devices such as a display 808, and printer 810.

The computer module 802 is connected to a computer network 812 via a suitable transceiver device 814, to enable access to e.g. the Internet or other network systems such as Local Area Network (LAN) or Wide Area Network (WAN).

The computer module 802 in the example includes a processor 818, a Random Access Memory (RAM) 820 and a Read Only Memory (ROM) 822. The computer module 802 also includes a number of Input/Output (I/O) interfaces, for example I/O interface 824 to the display 808, and I/O interface 826 to the keyboard 804.

The components of the computer module 802 typically communicate via and interconnected bus 828 and in a manner known to the person skilled in the relevant art.

The application program is typically supplied to the user of the computer system 800 encoded on a data storage medium such as a CD-ROM or floppy disk and read utilizing a corresponding data storage medium drive of a data storage device 830. The application program is read and controlled in its execution by the processor 818. Intermediate storage of program data maybe accomplished using RAM 820.

In the foregoing manner, a method and system for management of information for access control are disclosed. Only several embodiments are described. However, it will be apparent to one skilled in the art in view of this disclosure that numerous changes and/or modifications may be made without departing from the scope of the invention.

1. A method of management of information for access control to resources, the method comprising:
managing information associated with a plurality of users of the resources;
managing context information associated with the plurality of users; and
assigning an access authority to each of the plurality of users,
wherein the assignment of the access authority is based on the information associated with the plurality of users of the resources and the context information associated with the plurality of users.

2. A method as claimed in claim 1, wherein the context information comprises grouping information identifying a plurality of individual users as belonging to a group.

3. A method as claimed in claim 1, wherein the context information comprises temporal information on relationships between individual users and/or groups of users.

4. A method as claimed in claim 1, further comprising assigning different access levels to different access authority elements and assigning each user and/or group of users as belonging to one of the access levels, wherein the user and/or group of users in one access level hierarchically above one or more other access levels are assigned the access authority elements of said one access level and of the one or more other access levels.

5. A method as claimed in claim 4, wherein the assigning of the user and/or group of users, as belonging to one of the access levels is further based on the temporal information on the relationships between individual users and/or groups of users.

6. A method as claimed in claim 1, wherein one or more of the information associated with individual users of the resources, the context information associated with a plurality of users, and the access authority are in a format supporting inter- and intra-entity management of information for access control to the resources.

7. A system for management of information for access control to resources, the system comprising:
a user management unit for managing information associated with a plurality of users of the resources;
a context management unit for managing context information associated with the plurality of users; and
an access control management unit for assigning an access authority to each of the plurality of users,
wherein the access control management unit bases the assignment of the access authority on the information associated with the plurality of users of the resources from the user management unit and the context information associated with the plurality of users from the context management unit.

8. A system as claimed in claim 7, wherein the context information comprises grouping information identifying a plurality of individual users as belonging to a group of users.

9. A system as claimed in claim 7, wherein the context information comprises temporal information on relationships between individual users and/or groups of users.

10. A system as claimed in claim 7, wherein the access control management unit assigns different access levels to different access authority elements and assigns a user and/or group of users as belonging to one of the access levels, wherein the user and/or group of users in one access level hierarchically above one or more other access levels are assigned the access authority elements of said one access level and of the one or more other access levels.

11. A system is claimed in claim 10, wherein the access control management unit further bases the assigning of the user/or group of users as belonging to one of the access levels on the temporal information on the relationships between individual users and/or group of users.

12. A system as claimed in claim 7, wherein one or more of the information associated with individual users of the resources, the context information associated with a plurality of users, and the access authority are in a format supporting inter- and intra-entity management of information for access control.

13. A data storage medium containing computer readable code for instructing a computer to perform a method of management of information for access control to resources, the computer readable code instructing the computer to:
manage information associated with means for managing information associated with a plurality of users of the resources;
manage context information associated with the plurality of users; and
assign an access authority to each of the plurality of users,
wherein the assignment of the access authority is based on the information associated with the plurality of users of the resources and the context information associated with the plurality of users.

14. A system for management of information for access control to resources, the system comprising:
means for managing information associated with a plurality of users of the resources;
means for managing context information associated with the plurality of users; and
means for assigning an access authority to each of the plurality of users,
wherein the assignment of the access authority is based on the information associated with the plurality of users of the resources and the context information associated with the plurality of users.
